(19) United States
(12) Patent Application Publication
(10) Pub. No.: US 2013/0149140 A1
(43) Pub. Date: Jun. 13, 2013

(54) BEARING STRUCTURE AND COOLING FAN USING SAME

(71) Applicants: Bor-Haw Chang, New Taipei City (TW); Shu-Fen Liu, New Taipei City (TW)

(72) Inventors: Bor-Haw Chang, New Taipei City (TW); Shu-Fen Liu, New Taipei City (TW)

(73) Assignee: ASIA VITAL COMPONENTS CO., LTD., New Taipei City (TW)

(21) Appl. No.: 13/314,120

(22) Filed: Dec. 7, 2011

(51) Int. Cl. F04D 29/04; F16C 33/04

(52) U.S. Cl. 415/229; 384/276

(57) ABSTRACT

A bearing structure includes a main body internally defining a shaft space; the shaft space axially extends a full length of the main body and communicates with at least one extension space; and the extension space is radially outward extended from the shaft space and also axially extends a full length of the main body. The shaft space has a non-circular cross section. In a cooling fan using the bearing structure, a rotor shaft is inserted in the shaft space. With the shaft space having a non-circular cross section, it is possible to largely increase the support pressure of a lubricant filled between the rotor shaft and the shaft space and accordingly, reduce the frictional contact between the rotor shaft and the shaft space as well as the noise and vibration produced during the operation of the cooling fan.

### FIELD OF THE INVENTION

The present invention relates to a bearing structure, and more particularly to a bearing structure that internally defines a non-circular shaft space. The present invention also relates to a cooling fan that uses a bearing structure internally defining a non-circular shaft space for receiving a rotor shaft therein, so that the support pressure of a lubricant filled between the rotor shaft and the shaft space is increased, and the frictional contact between the rotor shaft and the bearing structure as well as the noise and vibration produced during operation of the cooling fan can be reduced.

### BACKGROUND OF THE INVENTION

Various kinds of electronic information products, such as computers and the like, are now very popular among people and applied to very wide applications. Due to consumers' demands, the electronic information technology has quickly developed and it has become a significant trend to increase the computing speed and the access capacity of the electronic information products. However, a high amount of heat is also produced when the elements of the electronic information products operate at high speed.

For example, the central processing unit (CPU) of a computer produces the largest part of heat in the computer. When the produced heat gradually increases and accumulates in the computer, it would bring the CPU to have lowered performance. And, when the accumulated heat exceeds the allowable upper limit, it would force the computer to crash or even cause burnout of the computer. Moreover, to solve the problem of electromagnetic wave radiation, most of the important and heat-producing components of the computer are enclosed in a metal case. Thus, it is an important issue as how to quickly guide out and dissipate the heat energy produced by the CPU and other heat-producing elements.

A general way to solve the problem of heat dissipation for CPU is to mount a heat sink and a cooling fan atop the CPU. The heat sink is provided on one side with a plurality of radiating fins, and another opposite side of the heat sink without the radiating fin is in direct contact with the CPU, so that the heat produced by the CPU is transferred to the radiating fins, from where the heat is radiated into the ambient air. The cooling fan cooperates with the heat sink to produce air flows that force the heat to more quickly dissipate into the ambient environment.

The cooling fan includes a seat and a rotor assembly. The seat is formed with a bearing cup, in which at least one bearing is provided. A lubricant is filled between the bearing cup and the bearing. The bearing internally defines a shaft space. A stator assembly is externally fitted around the bearing cup. The rotor assembly includes a hub having a plurality of blades and a rotor shaft. The rotor shaft is inserted in the shaft space. When the cooling fan operates, the rotor shaft of the rotor assembly rotates in and relative to the bearing. Since the lubricant provides uneven and insufficient support pressure when the rotor shaft rotates, the rotor shaft would collide with an inner wall surface of the shaft space to produce noise and vibration, preventing the rotor assembly from operating smoothly. Under these circumstances, the cooling fan would have shortened service life and even become damaged in a worse condition.

### SUMMARY OF THE INVENTION

A primary object of the present invention is to provide a bearing structure that internally defines a non-circular shaft space to reduce undesirable noise, frictional wearing and vibration occurred during the use of the bearing structure.

Another object of the present invention is to provide a cooling fan that uses a bearing structure internally defining a non-circular shaft space, so as to reduce undesirable noise, frictional wearing and vibration occurred during the operation of the cooling fan.

To achieve the above and other objects, the bearing structure according to the present invention includes a main body internally defining a shaft space; the shaft space axially extends a full length of the main body and communicates with at least one extension space; and the extension space is radially outward extended from the shaft space and also axially extends a full length of the main body.

To achieve the above and other objects, the cooling fan according to the present invention includes a seat, a stator assembly, a bearing structure, and a rotor assembly. The seat is formed with a bearing cup internally defining a receiving space, which axially extends a full length of the bearing cup. The stator assembly is externally mounted around the bearing cup. The bearing structure is received in the receiving space of the bearing cup, and includes a main body internally defining a shaft space. The shaft space axially extends a full length of the main body and communicates with at least one extension space. The shaft space has a non-circular cross section. The extension space is radially outward extended from the shaft space and also axially extends a full length of the main body. The rotor assembly includes a hub having a plurality of blades and at least one rotor shaft, and the rotor shaft is inserted in the shaft space of the bearing structure.

Since the shaft space of the bearing structure has a non-circular cross section, the lubricant filled between the rotor shaft and the bearing structure can have increased support pressure. With the bearing structure and the cooling fan of the present invention, undesirable frictional wearing, noise and vibration occurred during the operation of the cooling fan can be reduced to largely increase the service life of the bearing structure, the rotor shaft and the cooling fan.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a first embodiment of a bearing structure according to the present invention;

FIG. 2 is a top view of the bearing structure of FIG. 1;

FIG. 3 is a perspective view of a second embodiment of the bearing structure according to the present invention;

FIG. 4 is a top view of the bearing structure of FIG. 3;

FIG. 5 is a perspective view of a third embodiment of the bearing structure according to the present invention;

FIG. 6 is a top view of the bearing structure of FIG. 5;

FIG. 7 is a perspective sectional view of a fourth embodiment of the bearing structure according to the present invention;

FIG. 8 is a perspective sectional view of a fifth embodiment of the bearing structure according to the present invention;

FIG. 9 is an exploded perspective view of a first embodiment of a cooling fan according to the present invention;

FIG. 10 is an assembled view of FIG. 9;

FIG. 11 is a sectional view taken along line A-A of FIG. 10;

FIG. 12 is an exploded perspective view of a second embodiment of the cooling fan according to the present invention;

FIG. 13 is an exploded perspective view of a third embodiment of the cooling fan according to the present invention;

FIG. 14 is an exploded perspective view of a fourth embodiment of the cooling fan according to the present invention; and

FIG. 15 is a sectional view taken along line B-B of FIG. 10.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

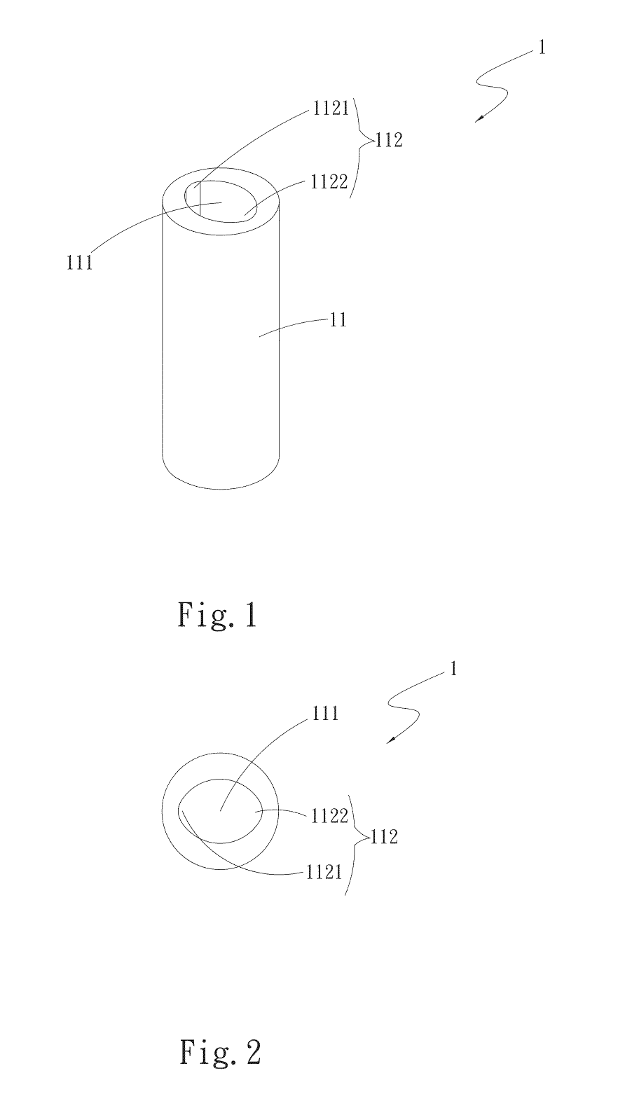

Please refer to FIGS. 1 and 2 that are perspective and top views, respectively, of a first embodiment of a bearing structure 1 according to the present invention. As shown, the bearing structure 1 in the first embodiment includes a main body 11, which internally defines a shaft space 111. The shaft space 111 axially extends a full length of the main body 11, and communicates with at least one extension space 112. The extension space 112 is radially outward extended from the shaft space 111 and also axially extends a full length of the main body 11.

The extension space 112 includes a first recess zone 1121 and a second recess zone 1122, which separately radially outward extend from two diametrically opposite ends of the shaft space 111 and communicate with the shaft space 111. The shaft space 111 has a non-circular cross section. The non-circular cross section may be any one of an elliptic, an oval, and a lime-shape cross section. In the illustrated first embodiment, the non-circular cross section is an elliptic cross section. However, it is understood the present invention is not restricted thereto.

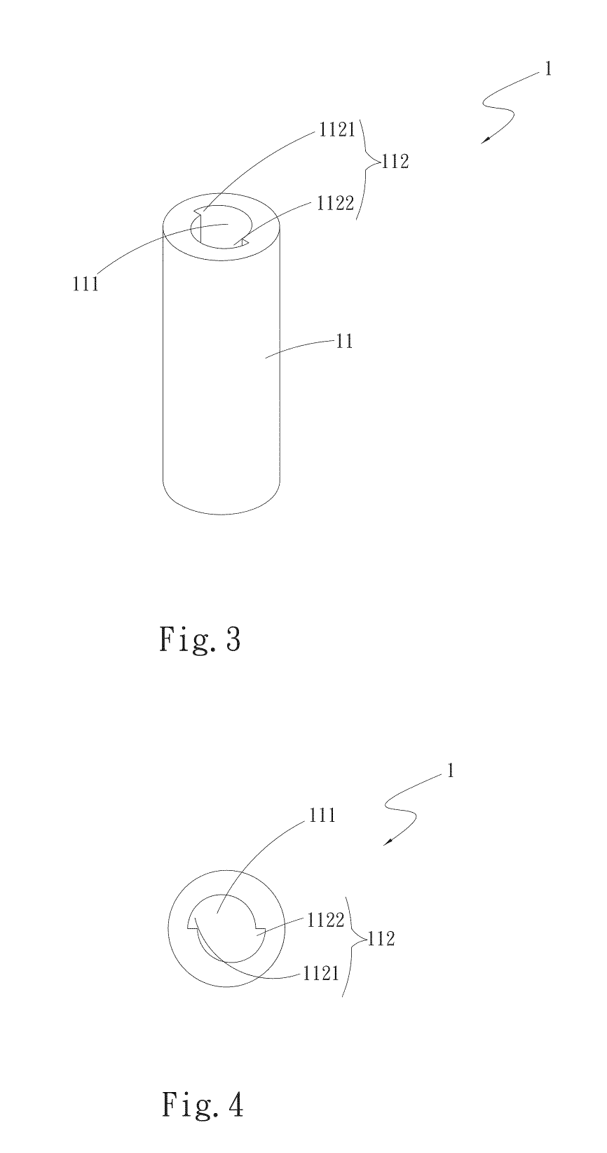

Please refer to FIGS. 3 and 4 that are perspective and top views, respectively, of a second embodiment of the bearing structure 1 according to the present invention. As shown, the bearing structure 1 in the second embodiment is generally structurally similar to the first embodiment, except that, in the second embodiment, the first recess zone 1121 and the second recess zone 1122 of the extension space 112 not only radially outward extend from two diametrically opposite ends of the shaft space 111, but also locate at two opposite sides of a center of the shaft space 111 to angularly space from each other by 180 degrees. The shaft space 111 has a non-circular cross section.

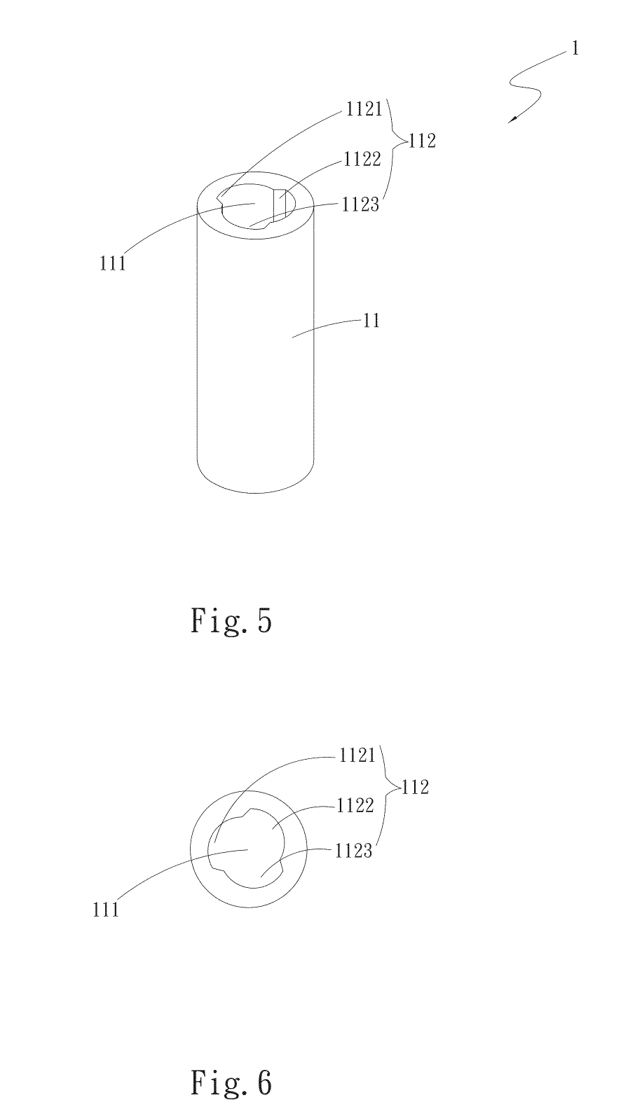

FIGS. 5 and 6 are perspective and top views, respectively, of a third embodiment of the bearing structure 1 according to the present invention. As shown, the bearing structure 1 in the third embodiment is generally structurally similar to the first embodiment, except that, in the third embodiment, the extension space 112 includes a first recess zone 1121, a second recess zone 1122 and a third recess zone 1123, which radially outward extend from and communicate with the shaft space 111, and are angularly spaced from one another by 120 degrees. The shaft space 111 has a non-circular cross section.

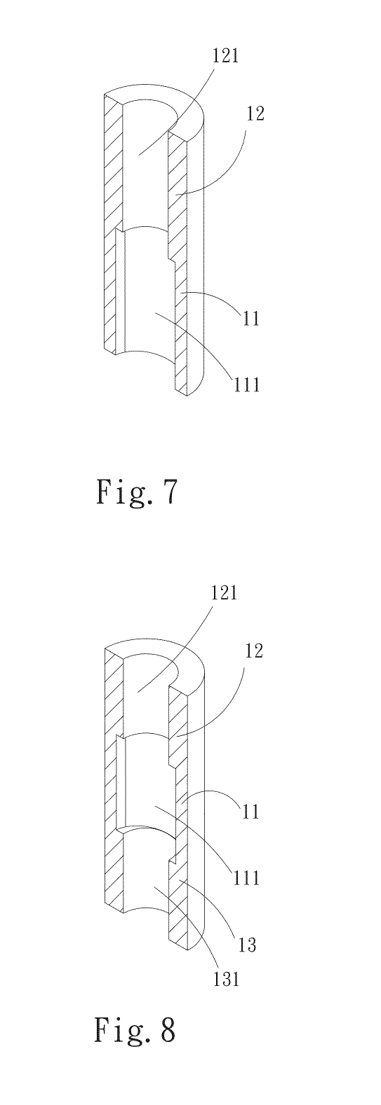

Please refer to FIG. 7 that is a perspective sectional view of a fourth embodiment of the bearing structure according to the present invention. As shown, the fourth embodiment is generally structurally similar to the first embodiment, except that, in the fourth embodiment, the main body 11 includes a first extended portion 12, which is axially outward extended from an end of the main body 11. The first extended portion 12 internally defines a first axial bore 121 communicating with the shaft space 111. The first axial bore 121 may have a circular cross section or a non-circular cross section. While the fourth embodiment is illustrated with the first axial bore 121 having a circular cross section, it is understood the present invention is not restricted thereto.

FIG. 8 is a perspective sectional view of a fifth embodiment of the bearing structure according to the present invention. As shown, the fifth embodiment is generally structurally similar to the first embodiment, except that, in the fifth embodiment, the main body 11 includes a first extended portion 12 and a second extended portion 13, which are separately axially outward extended from two opposite ends of the main body 11. The first and the second extended portion 12, 13 internally define a first and a second axial bore 121, 131, respectively, which communicate with the shaft space 111. Both the first and the second axial bore 121, 131 may have a circular cross section or a non-circular cross section. While the fifth embodiment is illustrated with the first and second axial bores all having a circular cross section, it is understood the present invention is not restricted thereto.

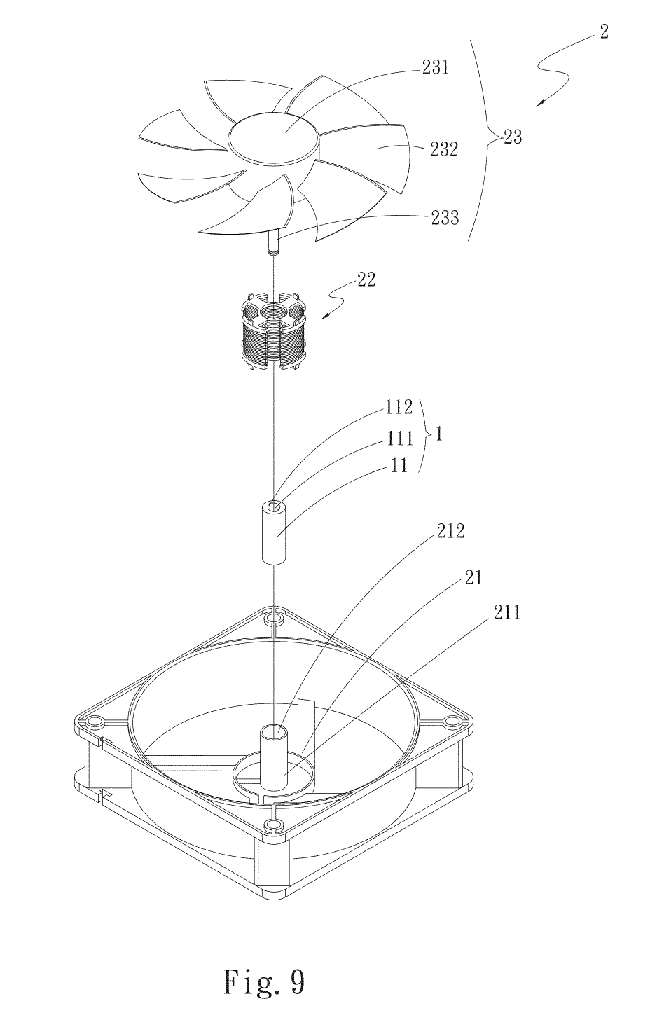

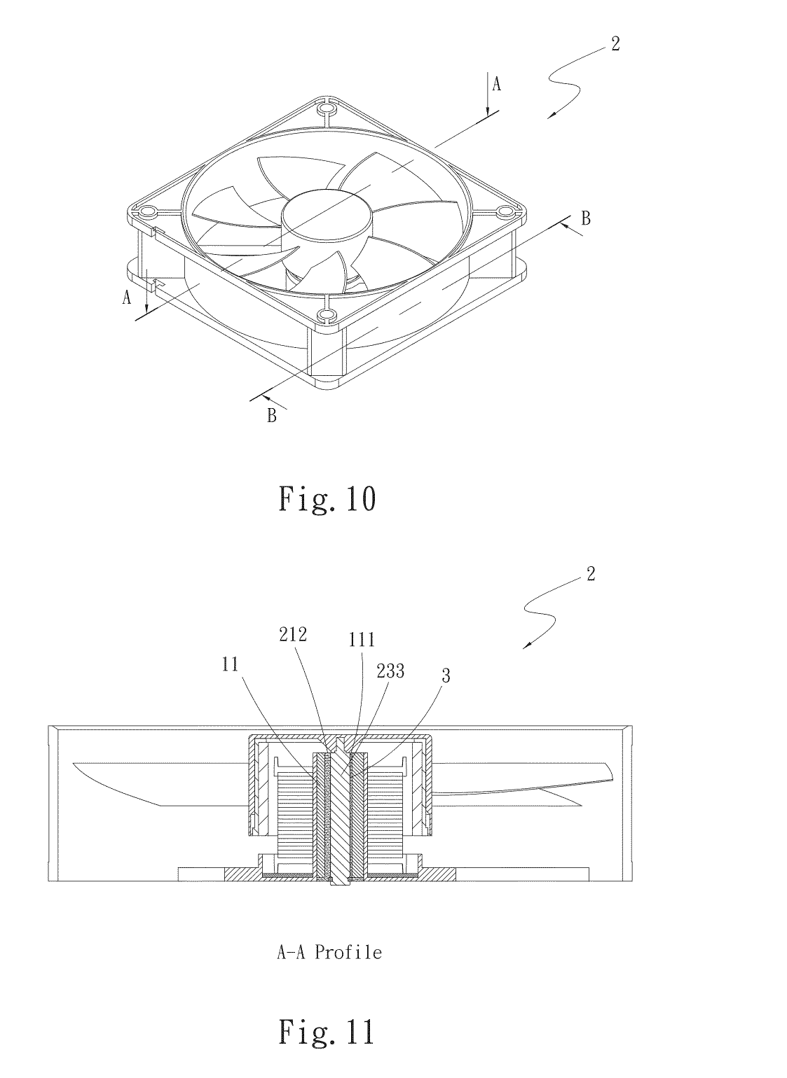

Please refer to FIGS. 9 and 10 that are exploded and assembled perspective views, respectively, of a first embodiment of a cooling fan 2 according to the present invention, and to FIG. 11 that is a sectional view taken along line A-A of FIG. 10. As shown, the cooling fan 2 in the first embodiment includes a seat 21, a stator assembly 22, a bearing structure 1, and a rotor assembly 23. The seat 21 is formed with a bearing cup 211, which internally defines a receiving space 212 axially extending a full length of the bearing cup 211.

The stator assembly 22 is externally mounted around the bearing cup 211.

Since the bearing structure 1 may be any one of the above described first to fifth embodiment of the bearing structure 1 according to the present invention, it is not discussed in details herein.

The rotor assembly 23 includes a hub 231 having a plurality of spaced blades 232 and at least one rotor shaft 233. The rotor shaft 233 is inserted in the shaft space 111 in the main body 11 of the bearing structure 1. A lubricant 3 is filled in a space left between the rotor shaft 233 and the shaft space 111.

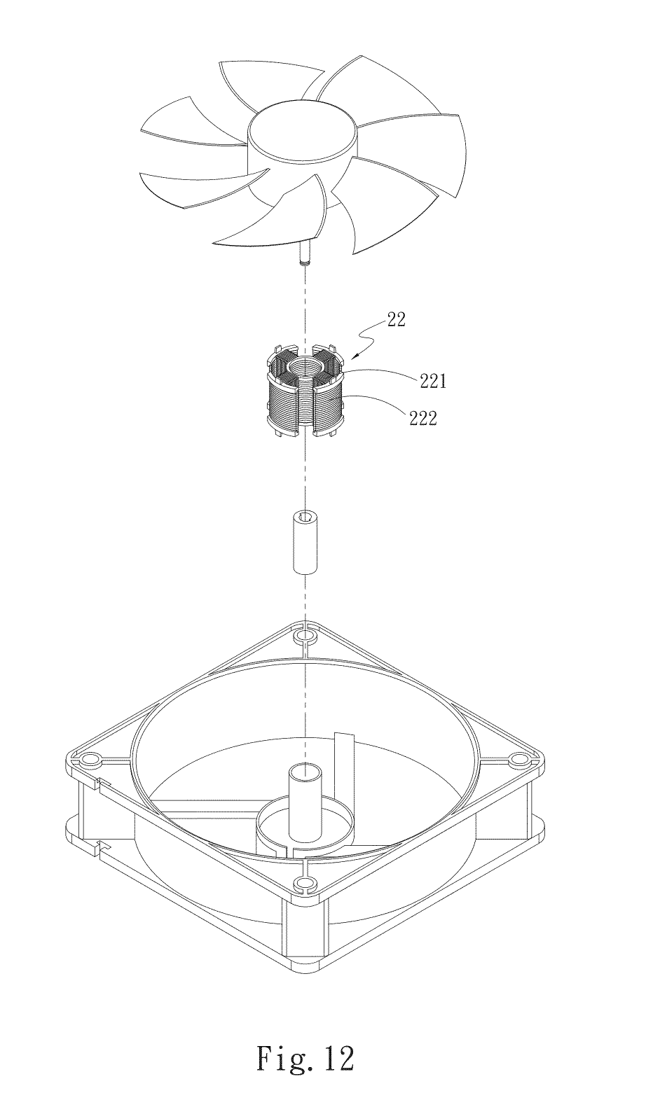

FIG. 12 is an exploded perspective view of a second embodiment of the cooling fan according to the present invention. As shown, the second embodiment is generally structurally similar to the first embodiment, except that, in the second embodiment, the stator assembly 22 includes a plurality of coils 221 and at least one silicon steel plate 222, and the coils 221 are externally wound around the silicon steel plate 222.

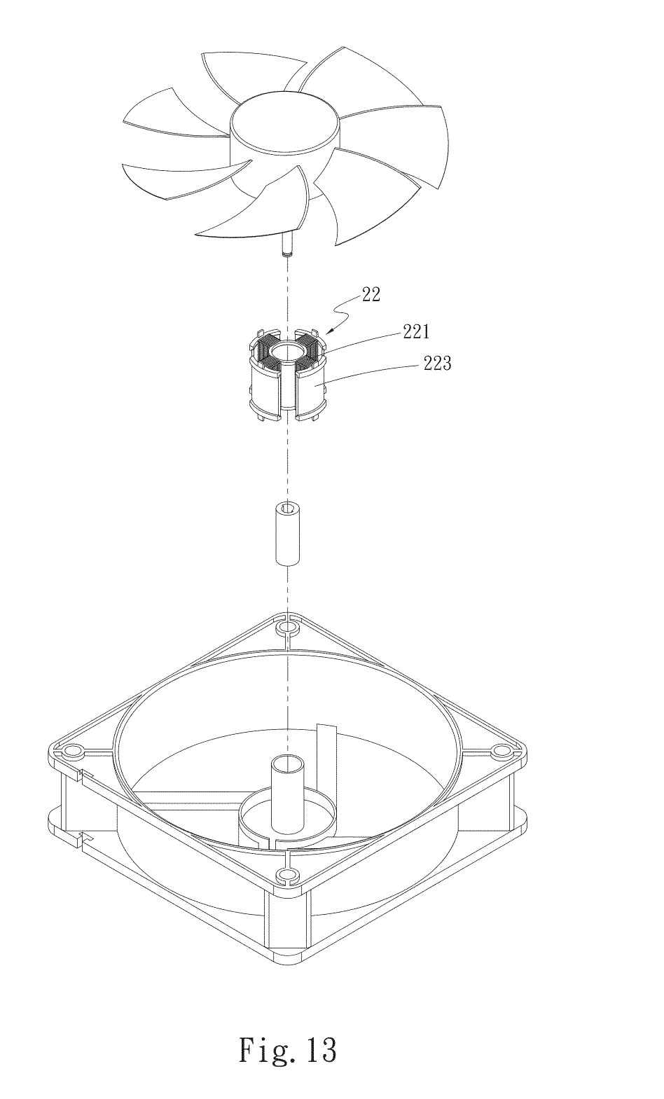

FIG. 13 is an exploded perspective view of a third embodiment of the cooling fan according to the present invention. As shown, the third embodiment is generally structurally similar to the first embodiment, except that, in the third embodiment, the stator assembly 22 includes a plurality of coils 221 and at least one magnetizable metal member 223, and the coils 221 are externally wound around the magnetizable metal member 223.

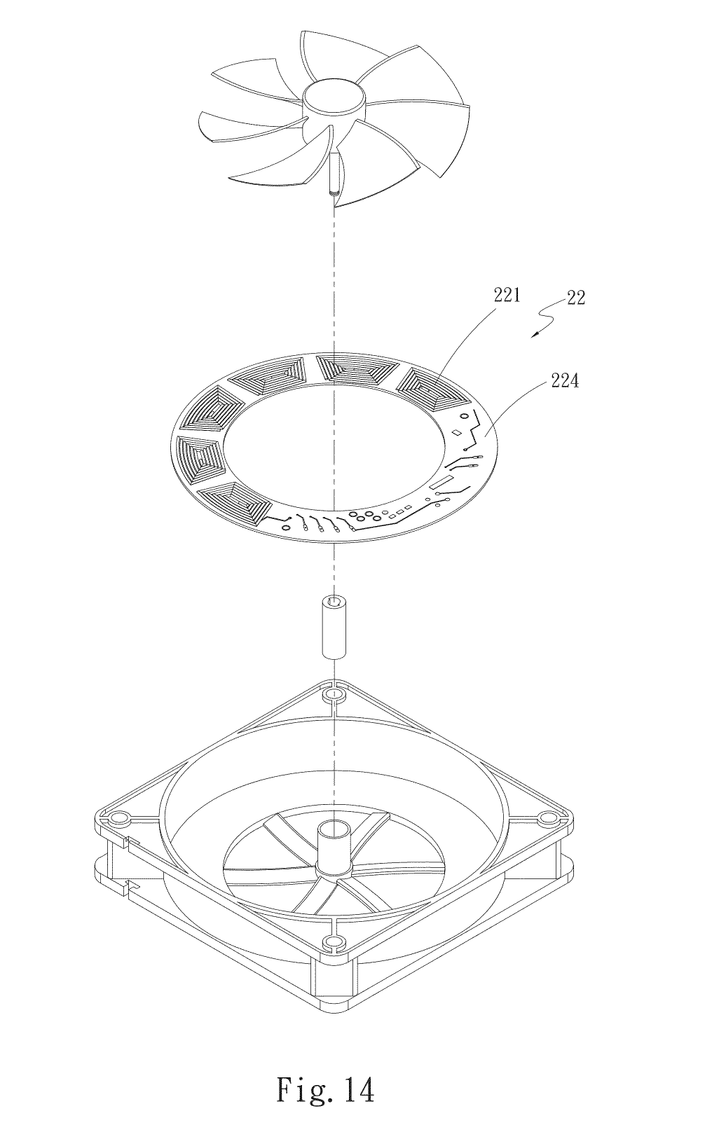

FIG. 14 is an exploded perspective view of a fourth embodiment of the cooling fan according to the present invention. As shown, the fourth embodiment is generally structurally similar to the first embodiment, except that, in the fourth embodiment, the stator assembly 22 includes a plurality of coils 221 and at least one circuit board 224, and the coils 221 are wound on the circuit board 224.

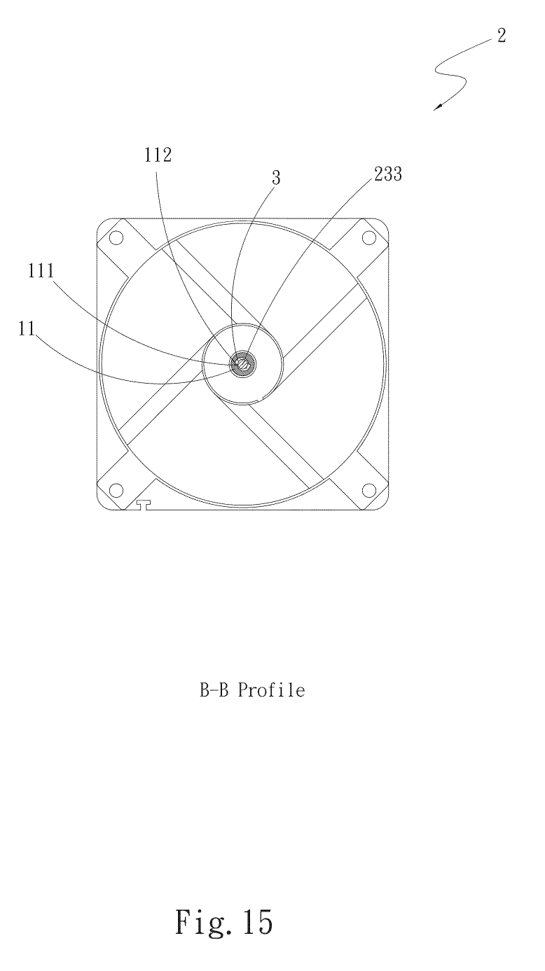

Please refer to FIG. 15 that is a sectional view taken along line B-B of FIG. 10, which is an assembled perspective view of the first embodiment of the cooling fan 2. As shown, the rotor shaft 233 is inserted in the shaft space 111 of the main body 11 of the bearing structure 1 and faces toward the extension space 112. Since the shaft space 111 has a non-circular cross section, the lubricant 3 filled in the space left between the rotor shaft 233 and the shaft space 111 and extension space 112 can have increased support pressure. With these arrangements, the rotor shaft 233 is present in the shaft space 111 of the bearing structure 1 in a suspended state without colliding against an inner wall surface of the shaft space 111 when the cooling fan 2 operates. In this manner, the undesirable noise, frictional wearing and vibration occurred during the operation of the cooling fan 2 can be reduced to largely increase the service life of the cooling fan 2.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A bearing structure, comprising a main body internally defining a shaft space; the shaft space axially extending a full length of the main body and communicating with at least one extension space; and the extension space being radially outward extended from the shaft space and also axially extending a full length of the main body.

2. The bearing structure as claimed in claim 1, wherein the extension space includes at least one first recess zone and at least one second recess zone; and the first and the second recess zone separately radially outward extending from two diametrically opposite ends of the shaft space and communicating with the shaft space; and wherein the shaft space has a non-circular cross section.

3. The bearing structure as claimed in claim 1, wherein the extension space includes at least one first recess zone and at least one second recess zone; and the first and the second recess zone not only separately radially outward extending from two diametrically opposite ends of the shaft space, but also locating at two opposite sides of a center of the shaft space to equally angularly space from each other and communicate with the shaft space; and wherein the shaft space has a non-circular cross section.

4. The bearing structure as claimed in claim 1, wherein the extension space includes at least one first recess zone, at least one second recess zone, and at least one third recess zone; and the first, the second and the third recess zone separately radially outward extending from the shaft space to angularly space from one another and communicate with the shaft space; and wherein the shaft space has a non-circular cross section.

5. The bearing structure as claimed in claim 1, wherein the main body includes a first extended portion axially outward extended from an end of the main body; the first extended portion internally defining a first axial bore communicating with the shaft space; and the first axial bore having a cross section selected from the group consisting of a circular cross section and a non-circular cross section.

6. The bearing structure as claimed in claim 1, wherein the main body includes a first extended portion and a second extended portion separately axially extended from two opposite ends of the main body; the first extended portion internally defining a first axial bore and the second extended portion internally defining a second axial bore; and the first and the second axial bore communicating with the shaft space and respectively having a cross section selected from the group consisting of a circular cross section and a non-circular cross section.

7. A cooling fan, comprising:
a seat being formed with a bearing cup internally defining a receiving space, and the receiving space axially extending a full length of the bearing cup;
a stator assembly being externally mounted around the bearing cup;
a bearing structure being received in the receiving space of the bearing cup; the bearing structure including a main body internally defining a shaft space; the shaft space axially extending a full length of the main body of the bearing structure and communicating with at least one extension space; and the extension space being radially outward extended from the shaft space and also axially extending a full length of the main body; and
a rotor assembly including a hub having a plurality of blades and at least one rotor shaft, and the rotor shaft being inserted in the shaft space of the bearing structure.

8. The cooling fan as claimed in claim 7, wherein the extension space includes a first recess zone and a second recess zone; and the first and the second recess zone separately radially outward extending from two diametrically opposite ends of the shaft space and communicating with the shaft space; and wherein the shaft space has a non-circular cross section.

9. The cooling fan as claimed in claim 7, wherein the extension space includes a first recess zone and a second recess zone; and the first and the second recess zone not only separately radially outward extending from two diametrically opposite ends of the shaft space, but also locating at two opposite sides of a center of the shaft space to equally angularly space from each other and communicate with the shaft space;
and wherein the shaft space has a non-circular cross section.

10. The cooling fan as claimed in claim 7, wherein the extension space includes a first recess zone, a second recess zone, and a third recess zone; and the first, the second and the third recess zone separately radially outward extending from the shaft space to angularly space from one another and communicate with the shaft space;
and wherein the shaft space has a non-circular cross section.

11. The cooling fan as claimed in claim 7, wherein the stator assembly includes a plurality of coils and at least one silicon steel plate, and the coils being externally wound around the silicon steel plate.

12. The cooling fan as claimed in claim 7, wherein the stator assembly includes a plurality of coils and at least one magnetizable metal member, and the coils being externally wound around the magnetizable metal member.

13. The cooling fan as claimed in claim 7, wherein the stator assembly includes a plurality of coils and at least one circuit board, and the coils being wound on the circuit board.

14. The cooling fan as claimed in claim 7, wherein the main body includes a first extended portion axially outward extended from an end of the main body; the first extended portion internally defining a first axial bore communicating with the shaft space; and the first axial bore having a cross section selected from the group consisting of a circular cross section and a non-circular cross section.

15. The cooling fan as claimed in claim 7, wherein the main body includes a first extended portion and a second extended portion separately axially outward extended from two opposite ends of the main body; the first extended portion internally defining a first axial bore and the second extended portion internally defining a second axial bore; and the first and the second axial bore communicating with the shaft space and respectively having a cross section selected from the group consisting of a circular cross section and a non-circular cross section.
